(19) United States
(12) Patent Application Publication
(10) Pub. No.: US 2026/0126940 A1
(43) Pub. Date: May 7, 2026

(54) STORAGE MEDIUM, INFORMATION PROCESSING APPARATUS, AND METHOD FOR CONTROLLING INFORMATION PROCESSING APPARATUS

(71) Applicant: CANON KABUSHIKI KAISHA, Tokyo (JP)

(72) Inventor: YUUKA HIROSUGI, Kanagawa (JP)

(21) Appl. No.: 19/377,143

(22) Filed: Nov. 3, 2025

(30) Foreign Application Priority Data
Nov. 5, 2024 (JP) 2024-194012

(51) Int. Cl. G06F 3/12

(52) U.S. Cl. CPC G06F 3/1225; G06F 3/1204; G06F 3/1228; G06F 3/1287

(57) ABSTRACT

A non-transitory computer-readable storage medium storing a program of an installer for an application for causing an information processing apparatus to execute a method, the method including: obtaining capability information on an operating system implemented in the information processing apparatus from the operating system and performing, based on the capability information on the operating system, control of whether to install a first driver being a virtual printer driver provided by a vendor of a printing apparatus, or to perform processing for assigning a second driver as the virtual printer driver, the second driver being different from the first driver and being a standard driver of the operating system.

### BACKGROUND

### Field of the Technology

The present disclosure relates to a storage medium, an information processing apparatus, and a method for controlling the information processing apparatus.

### Description of the Related Art

A change in an operating system (OS) environment due to an update of the OS or the like may lead to a problem where a driver provided by a vendor (a vendor-provided driver) becomes unusable. In other words, a vendor-provided driver usable before the OS update becomes unusable after the OS update. Thus, a problem may arise where installation of a vendor-provided driver fails after an OS update.

Patent Literature (Japanese Patent Laid-Open No. 2017-162106) discloses a method that displays a predetermined message upon failed installation of a vendor-provided driver to inform the user of a cause of the failed installation.

What is demanded is a method that allows the functions of a vendor-provided driver to be provided irrespective of a change in the OS environment.

### SUMMARY

A storage medium according to an aspect of the present disclosure is a non-transitory computer-readable storage medium storing a program of an installer for an application for causing an information processing apparatus to execute a method, the method comprising: obtaining capability information on an operating system implemented in the information processing apparatus from the operating system; and performing, based on the capability information on the operating system, control of whether to install a first driver being a virtual printer driver provided by a vendor of a printing apparatus, or to perform processing for assigning a second driver as the virtual printer driver, the second driver being different from the first driver and being a standard driver of the operating system.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing an example hardware configuration of a printing system;

FIG. 2A is a diagram showing an example configuration of a host computer installed with an OS that supports installation of a vendor-provided virtual printer driver;

FIG. 2B is a diagram showing an example configuration of a host computer installed with an OS that supports neither use nor installation of a vendor-provided virtual printer driver;

FIG. 3 is a block diagram showing an example configuration of an installer for an editing application;

FIG. 4 is a diagram showing an example configuration of the editing application;

FIG. 5 is a flowchart showing an example of processing for installing the editing application;

FIG. 6 is a sequence diagram showing an example of processing for assigning a standard driver as a virtual printer driver;

FIG. 7 is a flowchart showing an example of processing for activating the editing application;

FIG. 8 is a flowchart showing an example of processing for activating the editing application;

FIG. 9 is a diagram showing an example dialogue prompting an update of the editing application;

FIG. 10 is a flowchart showing an example of processing for activating the editing application;

FIG. 11 is a diagram showing an example dialogue prompting an update of the editing application;

FIG. 12 is a flowchart showing an example of processing for installing the editing application; and

FIG. 13 is a diagram showing an example of the flow up to the point where printing is executed by a printing apparatus.

### DESCRIPTION OF THE EMBODIMENTS

Preferred embodiments of the present disclosure are described in detail below with reference to the drawings attached hereto. Note that the embodiments below are not to limit the matters of the present disclosure, and also, not all the combinations of features described in the embodiments below are necessarily essential as solutions provided by the present disclosure. Note that the same configurations are described using the same reference numeral.

There is known a configuration where a program such as software receives input of data using a virtual driver installed on an information processing apparatus. In the environment where an information processing apparatus is installed with a virtual driver and an operating system (OS) as basic software, the virtual driver operates in accordance with the specifications defined by the OS. For example, the virtual driver can receive a predetermined instruction from given software via the OS, generate predetermined data, and output the predetermined data to a particular apparatus, particular software, a particular storage region, or the like. Then, upon receipt of the generated data generated by the virtual driver, the particular software or the like can perform particular processing using the generated data and output data generated by the particular processing. A vendor that provides particular software, a particular service, or the like can provide a vendor-provided virtual driver, a software installer, or the like corresponding to the software or the service. This allows a user to be provided with a way of inputting data from various programs capable of issuing predetermined instructions to the vendor-provided virtual driver and the like to the apparatus that provides particular software or service.

In recent years, for example, Windows (registered trademark) provides a standard class driver (hereinafter referred to as a standard driver) that can be commonly used by apparatuses provided by a plurality of vendors. Such a standard driver is included in the OS package and can be easily used by connection of a given apparatus to the information processing apparatus. A printing apparatus is an example of the apparatus connected to the information processing apparatus.

Using a standard driver eliminates the need to additionally install a model-specific printer driver suitable for the printing apparatus. This is therefore convenient for the user. Also, a standard driver is configured to be able to specify print functions based on “print device capabilities (hereinafter referred to as PDC)” generated based on information obtained from the printing apparatus connected. In a case where a user of an information processing apparatus having such a standard driver running wants to print using a printing apparatus connected to the information processing apparatus, the user can specify print functions suited to the capabilities of the printing apparatus.

It is conceivable in the future that a version update of the OS may result in a situation where the information processing apparatus implementing the updated OS no longer supports use or installation of a vendor-provided virtual printer driver. Note that it is expected that even in such a situation, a standard driver can still be used in the information processing apparatus implementing the updated OS.

In an OS environment that supports use of a standard driver but does not support use of a vendor-provided virtual printer driver (such an environment is hereinafter referred to as a new environment), a user can use particular software and the like provided by the vendor by extending the functions of the standard driver.

For example, a system that replaces the functions handled by the vendor-provided virtual printer driver can be built using, e.g., an extension application for extending the functions of a standard driver. Conversely, in an OS environment that supports use of the vendor-provided virtual printer driver (hereinafter referred to as an old environment), a system replacing the functions of the vendor-provided virtual printer driver may be not buildable using an extension application or the like. What is demanded is therefore a method which allows both of the old environment and the new environment to be supported in a transitional period in which the environment changes from the old environment to the new environment.

The following embodiments describe methods by which an information processing apparatus implementing a virtual printer driver provided by a vendor of a printing apparatus can provide the functions of the vendor-provided virtual printer driver irrespective of a change in the OS environment.

### First Embodiment

### Hardware Configuration

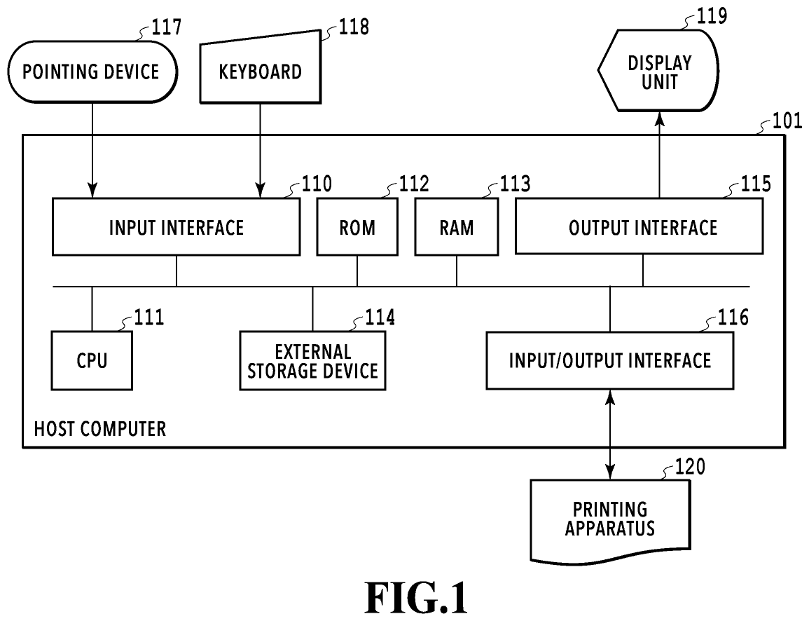

FIG. 1 is a block diagram showing an example hardware configuration of a printing system. Although a host computer 101 is described as an example of the information processing apparatus in the present embodiment, the information processing apparatus is not limited to this. For example, the information processing apparatus may be a desktop personal computer (PC), a node PC, a smartphone, or a tablet terminal.

The host computer 101 has an input interface 110, a CPU 111, a ROM 112, a RAM 113, an external storage device 114, an output interface 115, and an input/output interface 116. Also, input devices such as a keyboard 118 and a pointing device 117 are connected to the input interface 110. A display device such as a display unit 119 is connected to the output interface 115. Note that the display unit 119 may have a touch panel function. In this case, by being connected to an input/output interface (not shown), the display unit 119 can receive input operations performed on the display unit 119 by a user.

Control programs such as an initialization program are stored in the ROM 112. Stored in the external storage device 114 are programs such as an OS, an editing application to be described later, a group of other applications, an installer to be described later, and various drivers, as well as other various kinds of data. The RAM 113 is main memory of the host computer 101 and stores programs and the like temporarily. The RAM 113 is used as workspace memory or the like in execution of various programs stored in the external storage device 114, enabling the various programs to run in the host computer 101. Note that information processing according to the present embodiment is implemented by the CPU 111 loading control programs stored in the ROM 112 into the RAM 113 and executing the control programs.

A printing apparatus 120 is connected to the host computer 101 through the input/output interface 116. Note that a plurality of printing apparatuses 120 may be connected to the host computer 101. The host computer 101 and the printing apparatus 120 are configured separately here, but may be configured as a single information processing apparatus.

In the present embodiment, the printing apparatus 120 is, as an example, an inkjet printer that prints by ejecting ink to a paper surface, but may be one that executes printing using other methods (such as electrophotography).

### Software Configuration of the Printing System

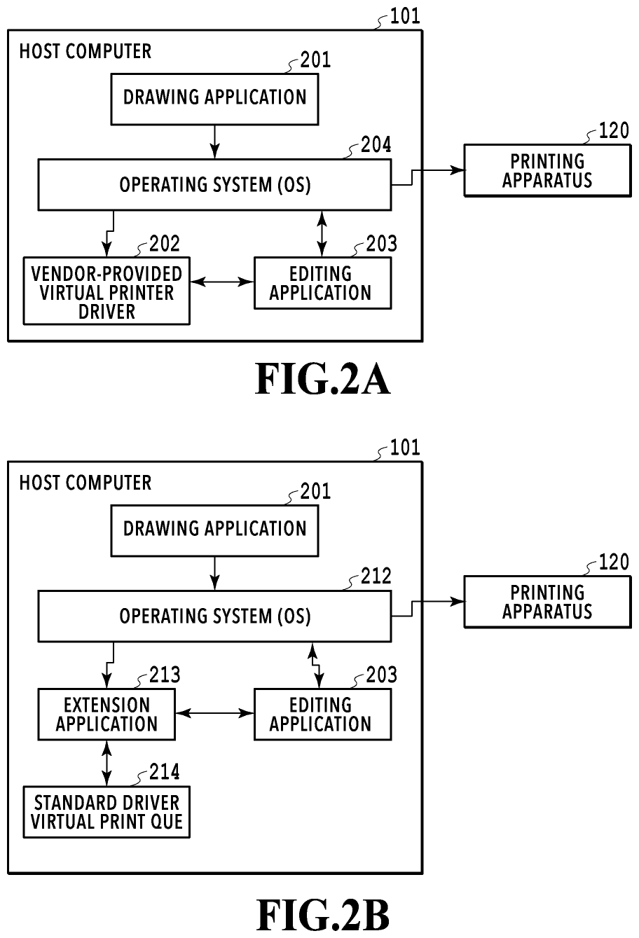

FIGS. 2A and 2B are diagrams showing an example software configuration of the printing system. FIG. 2A is a diagram showing an example configuration of the host computer 101 installed with an OS that supports installation of a vendor-provided virtual printer driver. An OS 204 is an OS that supports use of a vendor-provided virtual printer driver 202. What is meant by an OS that supports use of a vendor-provided virtual printer driver is, for example, an OS that does not prohibit execution and installation of a vendor-provided virtual printer driver with a function provided by the OS to restrict execution, installation, or the like of software. An example of the OS 204 is an OS of Windows (registered trademark) by Microsoft (registered trademark) in a version that supports use of a vendor-provided printer driver.

A drawing application 201 is software for generating content to be printed (drawing data). Examples of the drawing application 201 include a word processing application and a spreadsheet application. Upon receipt of a print request from a user, the drawing application 201 issues a print instruction to the OS 204. A print instruction includes print settings information for instructing a vendor-provided virtual printer driver 202 to perform a predetermined operation.

To generate print settings information, the drawing application 201 may display a print settings screen provided by any one of the vendor-provided virtual printer driver 202, the OS 204, and the drawing application 201. The print settings screen of the present embodiment is provided with, e.g., setting items with which printing settings can be configured based on capability information obtainable from the vendor-provided virtual printer driver 202, the print settings corresponding to the capability information (information settable as print settings).

The vendor-provided virtual printer driver 202 is a virtual driver capable of inputting print data to an editing application 203. The vendor-provided virtual printer driver 202 receives a print instruction including print settings information configured by the user from the drawing application 201 via the OS 204 and generates print data based on the content of the print settings information. The print data thus generated is inputted to the editing application 203 through a path predetermined in the present embodiment.

The editing application 203 is an application that uses the vendor-provided virtual printer driver 202 as one of methods for inputting print data thereto. The editing application 203 of the present embodiment is a layout editing application and receives an edit operation from a user wanting to print using the printing apparatus 120.

For example, the editing application 203 receives an edit operation to add predetermined data (such as document data) to drawing data generated by the drawing application 201. Then, in response to receiving the edit operation from the user, the editing application 203 can display a review of an edit result. In response to receiving an instruction from the user to print an image corresponding to the edit result, the editing application 203 can generate a print instruction including settings information corresponding to the edit result and transmit the generated print instruction to the printing apparatus 120 via the OS 204.

As described above, the editing application 203 can receive input of print data from the vendor-provided virtual printer driver 202. Note, however, that the editing application 203 is not limited to such an application. Examples of an application that can be applied to the present embodiment include an application having a function to upload input data to a server and an application having a function to convert input data to particular file format. Also, an application that can be applied to the present embodiment does not have to have a function to issue a print instruction.

FIG. 2B is a diagram showing an example configuration of the host computer 101 installed with an OS that does not support use and installation of a vendor-provided virtual printer driver. An OS 212 is an OS that does not support use of the vendor-provided virtual printer driver 202 but supports use of the standard driver. What is meant by an OS that does not support use of a vendor-provided virtual printer driver is, for example, an OS that prohibits execution and installation of a vendor-provided virtual printer driver with a function provided by the OS to restrict execution, installation, and the like of software. Examples of the OS 212 include an OS of Windows (registered trademark) by Microsoft (registered trademark) in a version that does not support use of a vendor-provided printer driver. Note that the following describes an example where the host computer 101 shown in FIG. 2B is installed with the standard driver.

A standard driver virtual print que 214 is a virtual print que corresponding to the standard driver. The standard driver in the present embodiment is not a printer driver unique to the model of the printing apparatus 120, but is a standard class driver that can be commonly used by printing apparatuses provided by a plurality of printer vendors. The following describes an example where the standard driver in the present embodiment is configured using an “IPP Class Driver” built in Windows (registered trademark) 11. The IPP Class Driver is a printer driver which executes print processing according to a standard print protocol called Internet Print Protocol (IPP) and is included in the OS package. The standard driver virtual print que 214 can be generated using the IPP Class Driver by use of a function built in the OS 212.

An extension application 213 is software that can extend the functions of the standard driver by being associated with the standard driver virtual print que 214. The extension application 213 is software that can be provided by the printing apparatus 120 and is not pre-included in (not packaged with) the OS.

Thus, the user needs to operate the host computer 101 to download and install the extension application 213 from a server (not shown) via the Internet. Alternatively, without the user intervention, the host computer 101 may automatically download and install the extension application 213 from the server via the Internet. Alternatively, the extension application 213 may be packaged with an installer for the editing application 203. The extension application 213 can provide functions that cannot be provided by the standard driver (extension functions) by editing the PDC generated by the standard driver.

Note that the host computer 101 may have a typical web browser and the like in addition to the software shown in FIGS. 2A and 2B.

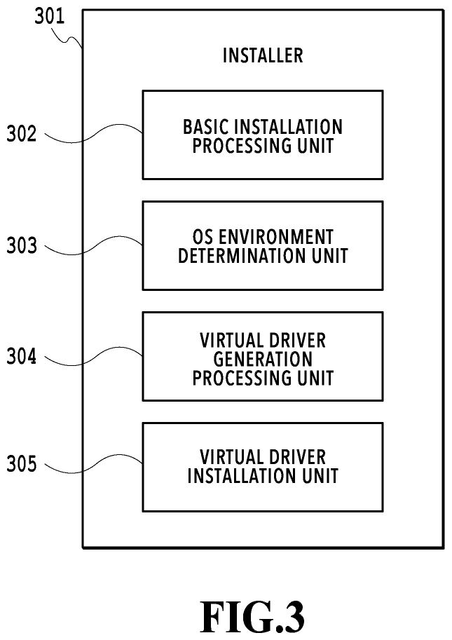

FIG. 3 is a diagram showing an example configuration of an installer for the editing application 203. An installer 301 has a basic installation processing unit 302, an OS environment determination unit 303, a virtual driver generation processing unit 304, and a virtual driver installation unit 305.

The OS environment determination unit 303, the virtual driver generation processing unit 304, and the virtual driver installation unit 305 perform processing related to a virtual printer driver that inputs data to the editing application 203. The basic installation processing unit 302 performs processing other than setup processing for the virtual driver, the processing being installation processing necessary for the editing application 203.

The OS environment determination unit 303 determines whether the OS environment where the installer 301 for the editing application 203 is running is an old environment or a new environment. Based on this determination, processing to be described later is executed by the virtual driver generation processing unit 304 or the virtual driver installation unit 305.

The virtual driver installation unit 305 installs the vendor-provided virtual printer driver 202 linked with the editing application 203. The vendor-provided virtual printer driver 202 may be packaged with the installer 301 or may be obtained from a server via the Internet.

The virtual driver generation processing unit 304 performs, e.g., issuance of an instruction to generate the standard driver virtual print que 214, issuance of an instruction to install the extension application 213, and processing associated therewith. Details of each processing will be described later.

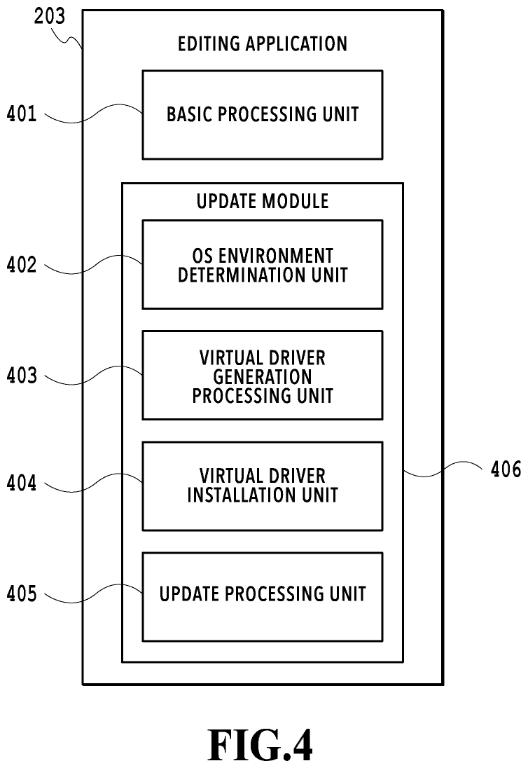

FIG. 4 is a diagram showing an example configuration of the editing application 203. The editing application 203 has a basic processing unit 401 and an update module 406. The update module 406 includes an OS environment determination unit 402, a virtual driver generation processing unit 403, a virtual driver installation unit 404, and an update processing unit 405.

The basic processing unit 401 executes the basic functions of the editing application 203. Processing for the basic functions of the editing application 203 in the present embodiment include, e.g., editing layouts, issuing print instructions to the printing apparatus 120, obtaining print data from the virtual printer driver, and performing processing for activating the editing application 203. The basic processing unit 401 can also perform, as will be described later, deleting the vendor-provided virtual printer driver 202, controlling display of dialogues, issuing a display instruction to activate a web browser and display a web page, and the like.

The update module 406 is a group of processes related to an update of the editing application 203. The update module 406 includes the units from the OS environment determination unit 402 to the update processing unit 405. The OS environment determination unit 402 has functions similar to those of the OS environment determination unit 303 included in the installer 301. The virtual driver generation processing unit 403 and the virtual driver installation unit 404 have functions similar to those of the virtual driver generation processing unit 304 and the virtual driver installation unit 305 included in the installer 301, respectively. Of the processes related to an update of the editing application 203, the update processing unit 405 performs ones irrelevant to the virtual printer driver. Note that the basic processing unit 401 may execute predetermined processing to update the editing application 203.

Note that the editing application 203 do not have to have all the units from the basic processing unit 401 to the update processing unit 405. The editing application 203 may or may not include the update module 406. Even in a case where the editing application 203 includes the update module 406, the editing application 203 does not have to have all the units from the OS environment determination unit 402 to the update processing unit 405.

### Flow of Installation of the Editing Application

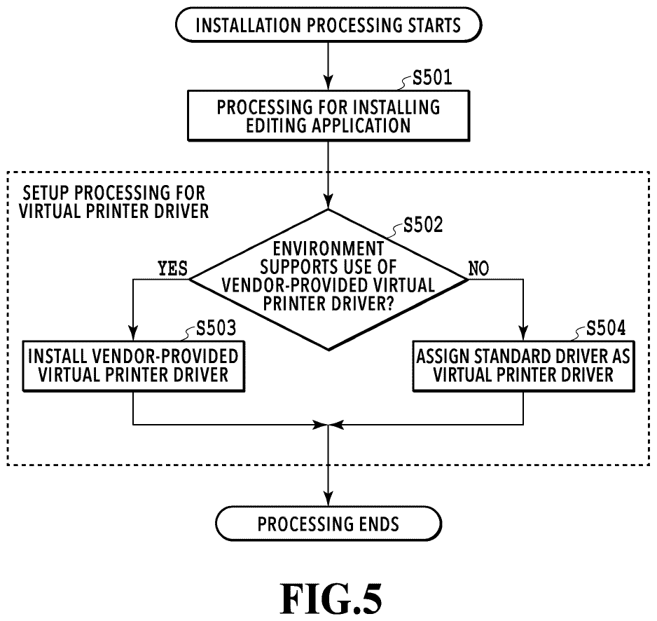

FIG. 5 is a flowchart showing an example of processing executed by the CPU 111 of the host computer 101 as a function of the installer 301. The processing shown in FIG. 5 is implemented by the CPU 111 of the host computer 101 by loading a control program stored in the ROM 112 and a program of the installer 301 stored in the external storage device 114 into the RAM 113 and executing the programs. Note that some or all of the functions of the processing shown in FIG. 5 may be implemented by hardware such as an ASIC or an electric circuit. The letter “S” used in the description of each process means that it is a step in the flowchart (this applies to the other flowcharts herein as well). Processing for installing the editing application 203 is described with reference to FIG. 5.

The processing shown in FIG. 5 starts once the CPU 111 detects a user operation of activating the installer 301 via an interface. Alternatively, the CPU 111 may automatically start the processing shown in FIG. 5 upon detecting that the host computer 101 is not installed with the editing application 203.

In S501, using the basic installation processing unit 302, the CPU 111 performs basic installation processing so that the editing application 203 can run on the OS 204 or the OS 212. This basic installation processing includes, e.g., processing for deploying modules for executing various processes of the editing application 203 onto the external storage device 114 of the host computer 101.

Also, in S501, the CPU 111, using the basic installation processing unit 302, performs processing for registering information related to a module for activating the editing application 203 into the OS as processing for installing the editing application 203. The processing for registering information related to a module for activating the editing application 203 into the OS is processing for registering a uniform resource identifier (URL) of the location of the activation module in the external storage device 114 to the OS. This URI is used in the event where the vendor-provided virtual printer driver 202 or the extension application 213 activates the editing application 203. Note that the processing executed by the basic installation processing unit 302 in S501 is processing for installing the editing application 203 and does not affect the virtual printer driver.

In S502, upon receipt of an instruction from the basic installation processing unit 302, the CPU 111 determines the OS environment using the OS environment determination unit 303. Using the OS environment determination unit 303, the CPU 111 obtains capability information on the OS from the OS and determines whether the current environment supports use of the vendor-provided virtual printer driver 202. The OS capability information in the present embodiment is, as an example, information indicative of the version of the OS, but is not limited to this. For example, the OS capability information may be information which can be used to identify whether use of the vendor-provided virtual printer driver is supported.

Specifically, the OS capability information may be a response to the OS through a particular application programming interface (API), information indicative of whether there is a particular API, or a predetermined set value set in the OS. The OS capability information may also be policy-related information.

In S502, if the OS environment determination unit 303 determines, based on the OS capability information, that the current environment supports installation of the vendor-provided virtual printer driver 202 (YES), the CPU 111 proceeds to S503. In other words, if it is determined that the installer 301 is running on the OS 204 that supports installation of the vendor-provided virtual printer driver 202, the CPU 111 proceeds to S503. For example, this determination is made by the CPU 111 by obtaining version information used to determine the OS environment and determining the OS environment where the installer 301 is running, based on the version information and information indicative of the version of the OS obtained as the OS capability information. The version information in the present embodiment is information indicative of the OS version that supports installation of the vendor-provided virtual printer driver 202 and is information described in an internal program of the installer 301 or an external file.

In S502, if the OS environment determination unit 303 determines, based on the OS capability information, that the current environment does not support installation of the vendor-provided virtual printer driver 202 (NO), the CPU 111 proceeds to S504. In other words, if it is determined that the installer 301 is running on the OS 204 that does not support installation of the vendor-provided virtual printer driver 202 and supports installation of the standard driver, the CPU 111 proceeds to S504. Thus, if the OS environment determination unit 303 determines that the current environment does not support use of the vendor-provided virtual printer driver 202, the CPU 111 proceeds to S504 without executing processing for installing the vendor-provided virtual printer driver 202.

In S503, the CPU 111 executes processing for installing the vendor-provided virtual printer driver 202 using the virtual driver installation unit 305. The virtual printer driver installed here is one specified by the provider of the editing application 203 and set to operate in cooperation with the editing application 203. Then, upon completion of the processing for installing the vendor-provided virtual printer driver 202 and setup processing associated therewith in S503, the CPU 111 ends the processing shown in FIG. 5. Specifically, if it is determined in S502 that the current environment supports installation of the vendor-provided virtual printer driver 202, in S503 the CPU 111 does not perform processing to be described later for assigning the standard driver as the virtual printer driver. Note that after the setup processing for the vendor-provided virtual printer driver 202, the CPU 111 may perform other installation processing necessary for the editing application 203 using the basic installation processing unit 302 or end the installation processing shown in FIG. 5.

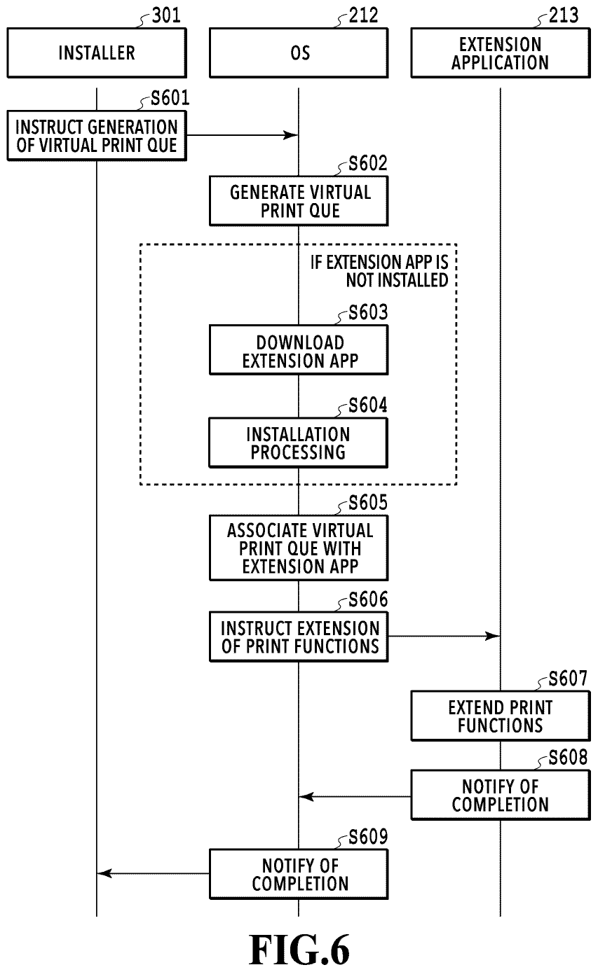

In S504, using the virtual driver generation processing unit 304, the CPU 111 performs processing for assigning the standard deriver as the virtual printer driver. Specifically, in S504, the CPU 111, using the virtual driver generation processing unit 304, issues an instruction to generate the standard driver virtual print que 214 to be generate using the IPP Class Driver. As will be described later, once the instruction to generate the standard driver virtual print que 214 is issued, the OS generates the standard driver virtual print que 214 and performs processing for associating the standard driver virtual print que 214 with the extension application 213. Details of the processing executed in S504 are described with reference to FIG. 6.

FIG. 6 is a sequence diagram showing an example of how the standard driver is assigned as the virtual printer driver in response to an instruction to generate the standard driver virtual print que 214 issued by the installer 301 in S504. The following describes an example where the OS in the sequence shown in FIG. 6 is the OS 212 that does not support installation of the vendor-provided virtual printer driver 202. Also, in the example described herein, the host computer 101 in the sequence shown in FIG. 6 is a computer not installed with the vendor-provided virtual printer driver 202, like the one shown in FIG. 2B.

In S601, the virtual driver generation processing unit 304 of the installer 301 issues an instruction to generate the standard driver virtual print que 214 to the OS 212. The instruction to generate the standard driver virtual print que 214 is to instruct the OS 212 to generate the standard driver virtual print que 214 to be allocated to the standard driver, and the instruction is issued using a function built in the OS 212 (e.g., Printui.dll). Printui.dll is a print-related function built in the OS 212. Executing Printui.dll with predetermined parameters assigned thereto enables the standard driver virtual print que 214 to be generated while specifying the standard driver installed on the OS 212 and the PDC generated by the standard driver. This links the PDC generated by the standard driver with the standard driver virtual print que 214. Also, the predetermined parameters include identification information for identifying the extension app to be downloaded in S603. In other words, the OS 212 identifies the extension app to download using the identification information included in the predetermined parameters. Specifically, although the identification information is the model name of the printing apparatus here, the present disclosure is not limited to this mode, and may be any type of information as long as it can be used to identify the editing application 203. Note that the predetermined parameters correspond to parameters for causing the OS 212 to execute not only processing in S602 to be described later, but also processing in S603 to S606. In other words, the processing in S601 can be said as processing for causing the OS 212 to execute the processing in S602 to S606 to be described later.

Also, simultaneously with the generation of the standard driver virtual print que 214, a file or the like can be specified, describing a virtual print que name, a virtual model name, a port to output data, and print-related information for the virtual print que.

Here, the standard driver typically generates PDC of a print que corresponding to the printing apparatus 120 based on the capability information on the printing apparatus 120 obtained from the printing apparatus 120. The capability information on the printing apparatus 120 is configuration information related to printing executable by the printing apparatus 120. However, because the printing apparatus 120 does not support the standard driver virtual print que 214, the standard driver cannot obtain the capability information for generating the PDC of the virtual print que and therefore cannot generate the PDC of the virtual print que. Thus, the file describing the capability information is specified in the instruction for generating the standard driver virtual print que 214, so that the standard driver can generate the PDC of the standard driver virtual print que 214 in S601. Also, the standard driver can generate the PDC at the timing at which the CPU 111 determines that the current environment does not support use of the vendor-provided virtual printer driver 202 in S502 using the OS environment determination unit 303.

The file describing the capability information on the printing apparatus 120 in S601 is a file packaged with the editing application 203. Also, the file is one created by the vendor providing the editing application 203 so that print data can be generated suitably as data to be passed to the editing application 203.

In S602, upon receipt of the instruction to generate the standard driver virtual print que 214 from the installer 301, the OS 212 generates the standard driver virtual print que 214 based on the content of the instruction received from the installer 301.

In S603, if the host computer 101 is not installed with the extension application 213 corresponding to the editing application 203, the OS 212 downloads the extension application 213 from a server via the Internet. A method for identifying the application to be downloaded here is as described earlier.

In S604, the OS 212 performs processing for installing the extension application 213. For example, after completing downloading the extension application 213 in S603, the virtual driver generation processing unit 304 can issue an instruction to install the extension application 213 to the OS 212. Then, upon receipt of the installation instruction, the OS 212 executes processing for installing the extension application 213. Note that after completing downloading the extension application 213 in S603, the OS 212 notifies the virtual driver generation processing unit 304 of the download completion. In this way, the OS 212 can receive the instruction for installing the extension application 213 from the virtual driver generation processing unit 304.

In S605, once the processing for installing the extension application 213 is completed in S604, the OS 212 associates the standard driver virtual print que 214 and the extension application 213 with each other. As a result of the association in S605, the OS 212 can activate various units of the extension application 213 by receiving a print instruction to the standard driver virtual print que 214.

In S606, once the association processing in S605 is completed, the OS 212 issues a print function extension instruction to the extension application 213. In the present embodiment, the print function extension instruction is an instruction to edit the PDC of the standard driver virtual print que 214. The OS 212 activates the extension application 213 and issues the print function extension instruction at the time of, e.g., the association of the standard driver virtual print que 214 and the extension application 213. The OS 212 can issue the print function extension instruction not only at the timing of the association of the standard driver virtual print que 214 and the extension application 213, but also at other timings such as the timing of displaying a print settings screen.

In S607, the extension application 213 extends the print functions upon receipt of the print function extension instruction in S606. Specifically, the extension application 213 edits the content of the PDC of the standard driver virtual print que 214 so that print data generated based on data inputted to the standard driver virtual print que 214 can be properly outputted to the editing application 203. As a result, the extension application 213 can generate print data that can be properly inputted to the editing application 203. Also, print data can be temporarily saved to any given storage region in the external storage device 114.

In S608, once the print function extension is completed in S607, the extension application 213 notifies the OS 212 of the completion of the print function extension processing. In S609, upon receipt of the print function extension processing completion notification from the extension application 213 in S608, the OS 212 notifies the installer 301 of completion of the standard driver virtual print que 214.

This is the processing for assigning the standard driver as the virtual printer driver performed in response to the instruction to generate the standard driver virtual print que 214 issued by the virtual driver generation processing unit 304 of the installer 301 in S504. As soon as this processing completes, the installer 301 ends the processing shown in FIG. 5. Note that after the processing shown in FIG. 5 ends, the basic installation processing unit 302 of the installer 301 may perform other installation processing necessary for the editing application 203.

According to the present embodiment, the installer for the editing application having a virtual printer driver as one of its data input methods determines the OS environment and executes installation processing if the current OS environment supports installation of the vendor-provided virtual printer driver. If the current OS environment does not support installation of the vendor-provided virtual printer driver, the installer for the editing application performs processing for assigning the standard driver as the virtual printer driver by issuing an instruction to generate a standard driver virtual print que.

Both of the old environment and the new environment can be supported with a single installer. Thus, functions of a driver provided by a vendor can be provided irrespective of a change in the OS environment. This allows the user to continue using the editing application.

### Second Embodiment

The first embodiment describes an installer system where an old environment and a new environment can both be supported, assuming new installation of an editing application. However, a case is conceivable where the OS 204 is changed to the OS 212 by an OS update with the editing application 203 already installed. In this case, a problem arises where the vendor-provided virtual printer driver formerly usable with the OS 204 becomes unusable.

The present embodiment describes a configuration which allows the functions of the vendor-provided printer driver to be provided even in a case where an old environment already installed with the editing application 203 is updated, making the vendor-provided virtual printer driver unusable. Hereinafter, the basic configuration of the present embodiment is the same as that of the first embodiment unless otherwise noted.

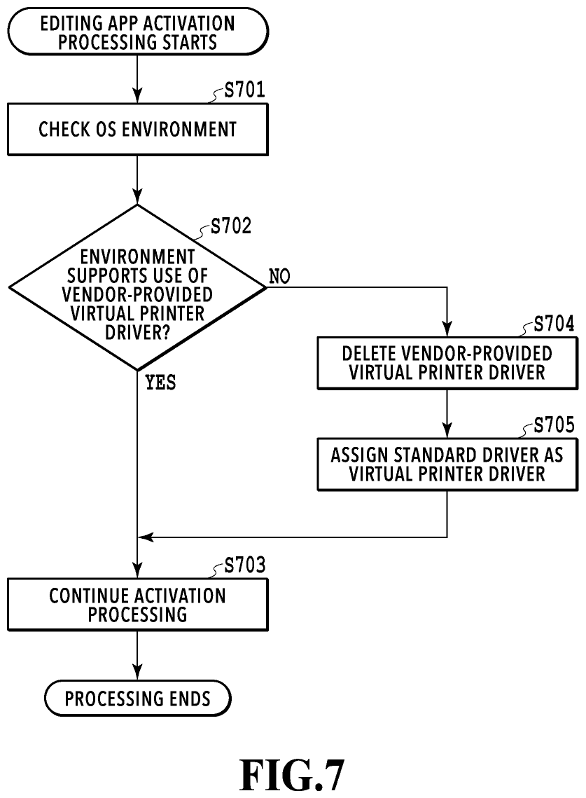

FIG. 7 is a flowchart showing an example of processing for activating the editing application 203, which is executed by the CPU 111 of the present embodiment as a function of the editing application 203. The software configuration of the host computer 101 in the present embodiment is the configuration shown in FIG. 2A. Thus, the host computer 101 in the present embodiment is installed with the vendor-provided virtual printer driver 202.

With the configuration described in the present embodiment, the functions of the printer driver provided by a vendor can be provided even in a case where the OS 204 is updated or has already been updated to the OS 212 by an automatic update function that the OS 204 has or by an update conducted by the user.

Upon receipt of a user operation of activating the editing application 203, the editing application 203 starts the activation processing shown in FIG. 7. Note that in a case where the host computer 101 is installed with a resident application related to the editing application 203, the resident application may execute the processing shown in FIG. 7 every time the OS is activated. A resident application is, for example, an application that is activated upon activation of the OS and, upon detection of a particular event (such as a change in the version of the OS or an error occurring on the OS), notifies the editing application 203 of the event.

In S701, the CPU 111 checks the OS environment using the OS environment determination unit 402. For example, the CPU 111, using the OS environment determination unit 402, obtains capability information on the OS from the OS and checks the OS environment. Note that OS capability information is the same as the information described in relation to S502 in the first embodiment and is therefore not described here. The method for determining the OS environment is also the same as the method described in relation to S502 in the first embodiment and is therefore not described here.

In S702, if the OS environment determination unit 402 determines that the current environment supports use of the vendor-provided virtual printer driver 202, i.e., has the OS 204 running (YES), the CPU 111 proceeds to S703. In other words, the OS environment determination unit 402 determines that the already-installed vendor-provided virtual printer driver 202 is still usable, and the CPU 111 proceeds to S703. In S702, if the OS environment determination unit 402 determines that the current environment does not support installation of the vendor-provided virtual printer driver 202, i.e., has the OS 212 running (NO), the CPU 111 proceeds to S704.

In S703, using the basic processing unit 401, the CPU 111 continues the processing for activating the editing application 203. As soon as the activation processing completes, the CPU 111 ends the processing shown in FIG. 7 using the basic processing unit 401. In other words, if it is determined in S702 that the current environment supports use of the vendor-provided virtual printer driver 202, the CPU 111 does not perform the processing for assigning the standard driver as the virtual printer driver in S703.

In S704, the CPU 111 deletes the vendor-provided virtual printer driver 202 using the basic processing unit 401. Because the OS environment determination unit 402 determines in S702 that the current environment does not installation of the OS environment determination unit 402, there is a possibility that the OS 204 shown in FIG. 2A has been changed to the OS 212. This is a situation where the already-installed vendor-provided virtual printer driver 202 is now unusable, and hence, the editing application 203 may be unable to provide its usual functions in this state. For this reason, in S704, the CPU 111 deletes the vendor-provided virtual printer driver 202 using the basic processing unit 401 and proceeds to S705. In S704, using the basic processing unit 401, the CPU 111 may uninstall the vendor-provided virtual printer driver 202 packaged together. Also, in S704, using the basic processing unit 401, the CPU 111 may directly delete the vendor-provided virtual printer driver 202 and its related files on the external storage device 114.

Note that in S704, the CPU 111 does not have to delete the vendor-provided virtual printer driver 202 using the basic processing unit 401. For example, the CPU 111 does not delete the vendor-provided virtual printer driver 202 in a case where, e.g., the processing for assigning the standard driver as the virtual printer driver in S705 to be described later can be performed properly without deleting the vendor-provided virtual printer driver 202. Alternatively, the CPU 111 does not have to delete the vendor-provided virtual printer driver 202 in S704 so that the vendor-provided virtual printer driver 202 will be usable again after the OS is downgraded.

In S705, once the deletion of the vendor-provided virtual printer driver 202 is completed in S704, the CPU 111, using the virtual driver generation processing unit 403, issues an instruction to generate the standard driver virtual print que 214. Then, the processing for assigning the standard driver as the virtual printer driver is performed by, e.g., the OS receiving the generation instruction. Specifically, after the content of the PDC of the standard driver virtual print que generated using the IPP Class Driver is edited, the CPU 111 proceeds to S703. The processing for assigning the standard driver as the virtual printer driver is the same as that in S504 in the first embodiment and is therefore not described here.

After the standard driver is applied as the virtual printer driver in S705, in S703 the CPU 111 continues the processing for activating the editing application 203 using the basic processing unit 401, and after completion of the processing for activating the editing application 203, ends the processing shown in FIG. 7.

According to the present embodiment, even in a case where the OS is changed to one that does not support use of a vendor-provided printer driver with an editing application already installed, the functions of the driver provided by a vendor can be provided irrespective of the change in the OS environment. In other words, because the standard driver is assigned as the virtual printer driver based on an instruction from the editing application and provides a mechanism replacing the functions of the vendor-provided virtual printer driver, the user can continue using the editing application.

### Third Embodiment

The second embodiment describes the processing for assigning the standard driver as the vendor-provided virtual printer driver performed in a case where the OS is changed to one that does not support use of the vendor-provided virtual printer driver with the editing application 203 already installed. However, the situation described in the second embodiment may require an update of the editing application 203 depending on the editing application 203.

For example, the editing application 203 needs to be updated in a case where the installed editing application 203 is in an old version not designed for the new environment because the following problem may arise in certain situations.

Specifically, situations are conceivable where the editing application 203 does not include the virtual driver generation processing unit 403 or where a file describing capability information on the printing apparatus 120 is not packaged together.

In such situations, the OS cannot generate the standard driver virtual print que 214 and thus faces a problem of failing to execute the processing for assigning the standard driver as the virtual printer driver based on an instruction from the virtual driver generation processing unit 403. Thus, the editing application 203 needs to be updated to a new version designed for the new environment.

The present embodiment describes updating the editing application 203 and performing the processing for assigning the standard driver as the virtual printer driver in a case where the OS is updated to one that does not support use of the vendor-provided virtual printer driver.

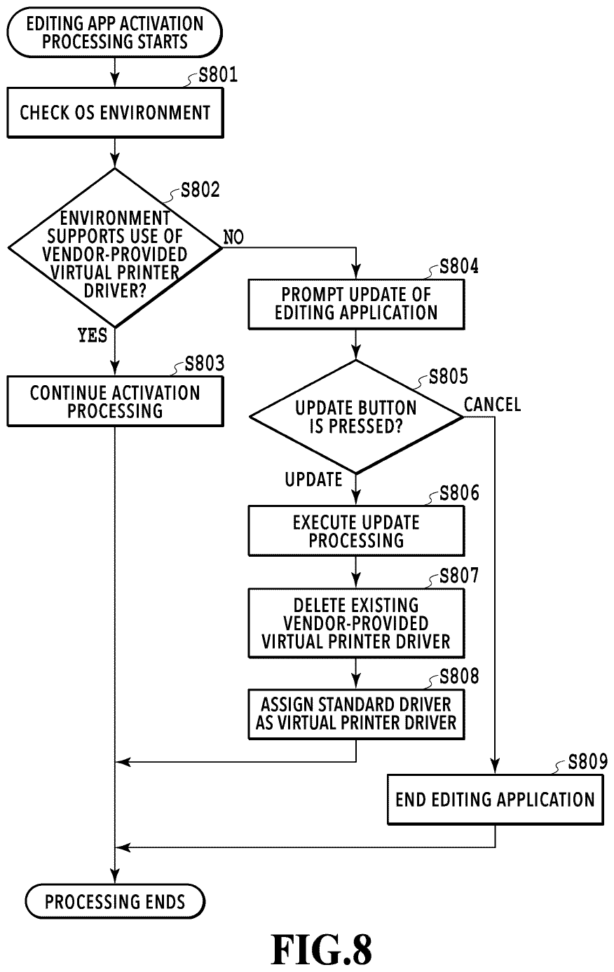

FIG. 8 is a flowchart showing an example of processing for activating the editing application 203, which is executed by the CPU 111 in the present embodiment as a function of the editing application 203. The software configuration of the host computer 101 in the present embodiment is the configuration shown in FIG. 2A. Thus, the host computer 101 of the present embodiment is installed with the vendor-provided virtual printer driver 202.

The present embodiment describes a configuration where the functions of the printer driver provided by a vendor can be provided even in a case where the OS 204 is updated or has already been updated to the OS 212 by an automatic update function that the OS 204 has or by an update conducted by the user.

Upon receipt of a user operation of activating the editing application 203, the editing application 203 starts the activation processing shown in FIG. 8. Note that like in the second embodiment, in a case where the host computer 101 is installed with a resident application related to the editing application 203, the resident application may execute the processing shown in FIG. 8 every time the OS is activated. S801 to S803 are the same as S701 to S703 in the second embodiment, respectively, and are therefore not described here. Note that if it is determined in S802 that the current environment supports use of the vendor-provided virtual printer driver 202, the CPU 111 does not perform the processing for activating the standard driver as the virtual printer driver and continues the activation processing in S803.

In a case where the OS 204 of the host computer 101 shown in FIG. 2A has been changed to the OS 212, the already-installed vendor-provided virtual printer driver 202 becomes unusable. Because the editing application 203 cannot provide its usual functions in this state, the processing for assigning the standard driver as the virtual printer driver needs to be performed like in S504 in the first embodiment. The present embodiment assumes a situation where the editing application 203 is not packaged with a file describing capability information on the printing apparatus 120 or a situation where the virtual driver generation processing unit 403 is not included. In such situations, the OS 212 cannot generate the standard driver virtual print que 214. Thus, the OS or the like cannot execute the processing for assigning the standard driver as the virtual printer driver.

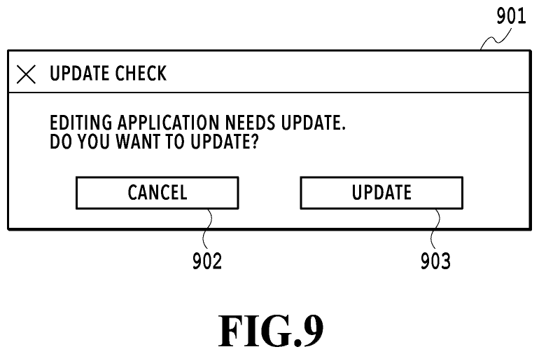

For this reason, in S804, the CPU 111, using the basic processing unit 401, displays a dialogue prompting an automatic update of the editing application 203 before the activation of the editing application 203. FIG. 9 shows an example of the screen displayed as the dialogue in S804.

FIG. 9 is a diagram showing an example of an update checking screen 901 for prompting a user for an automatic update of the editing application 203. The present embodiment describes an example where the update checking screen 901 is displayed as a dialogue.

A message prompting a user for an automatic update is displayed on the update checking screen 901. The update checking screen 901 is also provided with a Cancel button 902 for receiving the user's disagreement on the update and an Update button 903 for receiving the user's agreement on the update.

In S805, the CPU 111, using the basic processing unit 401, determines whether the Update button 903 has been pressed. If the basic processing unit 401 detects a user operation on the Update button 903 and determines that the Update button 903 has been pressed (YES), the CPU 111 proceeds to S806. If the basic processing unit 401 detects a user operation on the Cancel button 902 and determines that the Cancel button 902 has been pressed (NO), the CPU 111 proceeds to S809. In other words, the CPU 111 does not perform processing for updating the editing application 203 to be described later if the basic processing unit 401 detects a user operation on the Cancel button 902. In S809, using the basic processing unit 401, the CPU 111 ends the editing application 203 and ends the processing shown in FIG. 8.

In S806, the CPU 111, using the update processing unit 405, performs processing for updating the editing application 203. This processing includes obtaining data necessary for the update via the Internet, updating data already existing in the external storage device 114, and the like.

In S807, once the update of the editing application 203 is completed in S806, the CPU 111 deletes the vendor-provided virtual printer driver 202 using the basic processing unit 401. Note that, as described earlier, the CPU 111 does not have to delete the vendor-provided virtual printer driver 202 using the basic processing unit 401. S807 and S808 are the same as S704 and S705 in the second embodiment, respectively, and are therefore not described here. Note that after assigning the standard driver as the virtual printer driver in S808, the CPU 111 ends the editing application 203 without continuing the processing for activating the editing application 203 and ends the processing shown in FIG. 8.

According to the present embodiment, the editing application 203 is updated in a case where the OS is changed to one that does not support use of the vendor-provided virtual printer driver with the editing application already installed. The processing for assigning the standard driver as the virtual printer driver is thus made executable, so that the functions of the vendor-provided driver can be provided. Thus, the user can continue using the editing application 203.

### Fourth Embodiment

The third embodiment describes an example where the update processing unit 405 of the editing application 203 updates the editing application 203 by obtaining data necessary for the update via the Internet. However, depending on the configuration of the editing application 203, the editing application 203 may not include the update processing unit 405. In this case, the editing application 203 cannot be updated using the update processing unit 405, and the user therefore needs to perform a predetermined operation to obtain the editing application 203 in a new version.

The present embodiment describes an example where the editing application 203 is updated through a user operation in a case where the OS has been changed to one that does not support use of the vendor-provided virtual printer driver 202 with the editing application 203 already installed.

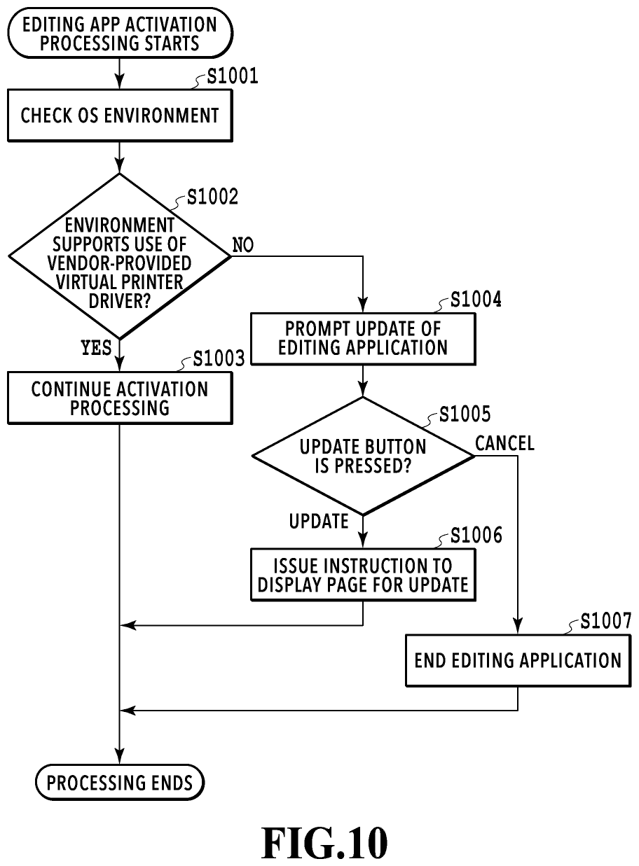

FIG. 10 is a flowchart showing an example of processing for activating the editing application 203, which is executed by the CPU 111 of the present embodiment as a function of the editing application 203. The software configuration of the host computer 101 in the present embodiment is the configuration shown in FIG. 2A. Hence, the host computer 101 in the present embodiment is installed with the vendor-provided virtual printer driver 202.

The present embodiment describes a configuration which allows the functions of the printer driver provided by a vendor to be provided even in a case where the OS 204 is updated or has already been updated to the OS 212 by an automatic update function that the OS 204 has or by an update conducted by the user.

Upon receipt of a user operation of activating the editing application 203, the editing application 203 starts the activation processing shown in FIG. 10. Note that like in the third embodiment, in a case where the host computer 101 is installed with a resident application related to the editing application 203, the resident application may execute the processing shown in FIG. 10 every time the OS is activated. S1001 to S1003 are the same as S801 to S803 in the third embodiment, respectively, and are therefore not described here. Note that if it is determined in S1002 that the current environment supports use of the vendor-provided virtual printer driver 202, in S1003 the CPU 111 continues the activation processing without performing the processing for assigning the standard driver as the virtual printer driver.

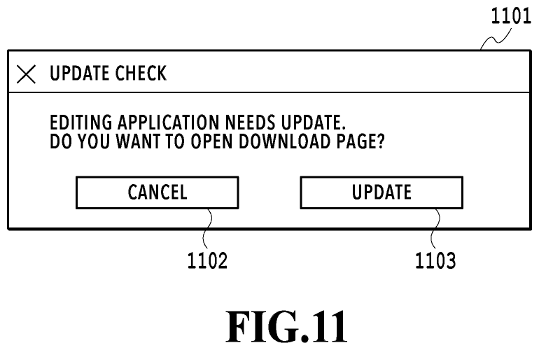

In S1004, using the basic processing unit 401, the CPU 111 displays a dialogue for prompting a manual update of the editing application 203 before activating the editing application 203. FIG. 11 shows an example of the screen displayed as the dialogue in S1004.

FIG. 11 is a diagram showing an example of an update check screen 1101 for prompting the user for a manual update of the editing application 203. The present embodiment describes an example where the update check screen 1101 is displayed as a dialogue in the present embodiment.

A message prompting the user for a manual update is displayed on the update check screen 1101. The update check screen 1101 is provided with a Cancel button 1102 for receiving the user's disagreement on displaying a page for updating the editing application 203 and an Update button 1103 for receiving the user's agreement on displaying the page.

In S1005, the CPU 111, using the basic processing unit 401, determines whether the Update button 1103 has been pressed. If the basic processing unit 401 detects a user operation on the Update button 1103 and determines that the Update button 1103 has been pressed (YES), the CPU 111 proceeds to S1006. If the basic processing unit 401 detects a user operation on the Cancel button 1102 and determines that the Cancel button 1102 has been pressed (NO), the CPU 111 proceeds to S1007. In other words, if the basic processing unit 401 detects a user operation on the Cancel button 1102, the CPU 111 proceeds to S1007 without displaying the page for updating the editing application 203. In S1007, the CPU 111 ends the editing application 203 using the basic processing unit 401 and ends the processing shown in FIG. 10.

In S1006, the CPU 111 issues a display instruction to the OS 212 using the basic processing unit 401 to display the page for obtaining an installer for the editing application in a new version. Then, using the basic processing unit 401, the CPU 111 ends the editing application 203 in the current version without continuing the processing for activating the editing application 203 in the current version and ends the processing shown in FIG. 10.

Upon receipt of the display instruction issued by the basic processing unit 401, the CPU 111 activates the web browser using the OS 212 and displays the page for obtaining an installer for the editing application 203 in the new version through the web browser. Specifically, after activating the web browser, the CPU 111 can display the aforementioned page by specifying the URL of a web page preset in the editing application 203. By operating the web browser, the user can download the installer for the editing application 203 in the new version and save the installer to the external storage device 114.

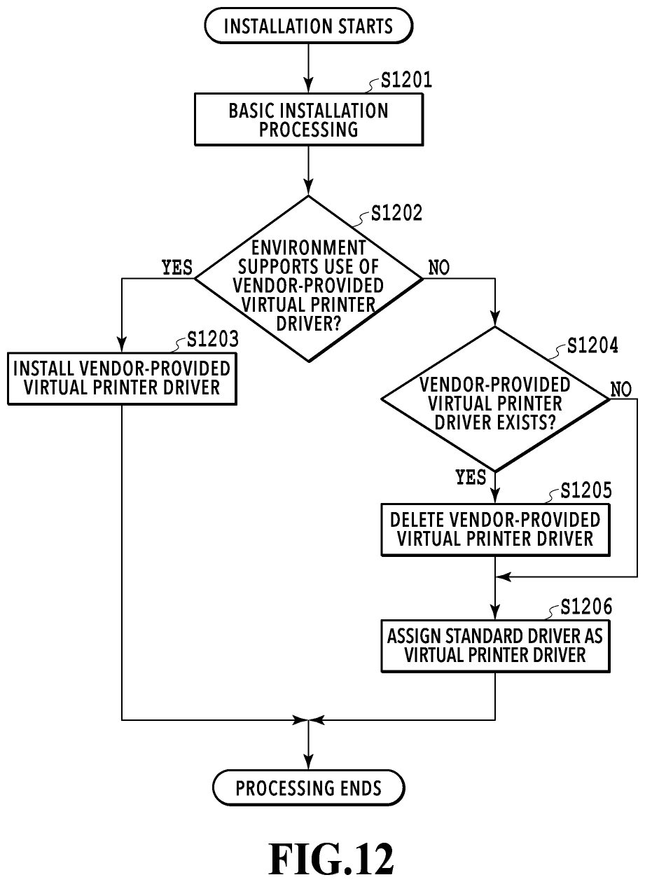

After obtaining the installer for the editing application 203 in the new version, the user activates the installer and installs the editing application 203 in the new version. This installer is configured similarly to the installer 301 shown in FIG. 3. FIG. 12 shows a flowchart showing an example of processing executed by the CPU 111 as a function of the installer 301 after the installer is obtained in S1006. The processing shown in FIG. 12 starts once the installer obtained in S1006 receives a user operation for executing processing for installing the editing application 203 in the new version. S1201 to S1203 are the same as S501 to S503, respectively, and are therefore not described here. Note that if it is determined in S1202 that the current OS environment supports use of the vendor-provided virtual printer driver 202, in S1203 the CPU 111 does not perform the processing for assigning the standard driver as the virtual printer driver. Also, if the OS environment determination unit 303 determines in S1202 that the current environment does not support use of the vendor-provided virtual printer driver 202, the CPU 111 proceeds to S1204 without executing the processing for installing the vendor-provided virtual printer driver 202.

In S1204, if it is determined in S1202 that the current environment does not support use of the vendor-provided virtual printer driver 202, the CPU 111, using the basic installation processing unit 302, determines whether the vendor-provided virtual printer driver 202 exists. Because the present embodiment assumes an update from the existing editing application 203 and therefore assumes a situation where the vendor-provided virtual printer driver 202 exists. Assuming such a situation, it is determined whether the vendor-provided virtual printer driver 202 exists.

In S1204, if the basic installation processing unit 302 determines that the vendor-provided virtual printer driver 202 does not exist (NO), the CPU 111 proceeds to S1206. In S1206, the CPU 111 performs the processing for assigning the standard driver as the virtual printer driver using the virtual driver generation processing unit 304, and ends the processing shown in FIG. 12. Note that using the basic installation processing unit 302, the CPU 111 may perform other installation processing necessary for the editing application 203 before ending the processing shown in FIG. 12.

In S1204, if the basic installation processing unit 302 determines that the vendor-provided virtual printer driver 202 exists (YES), the CPU 111 proceeds to S1205. In S1205, the CPU 111 deletes the vendor-provided virtual printer driver using the basic installation processing unit 302 and proceeds to S1206. Note that as described earlier, the CPU 111 does not have to delete the vendor-provided virtual printer driver 202 using the basic installation processing unit 302.

Completing the processing as to the installer 301 of the editing application 203 in the new version completes the processing for assigning the standard driver as the virtual printer driver.

According to the present embodiment, the user can obtain data necessary for updating the editing application in a case where the existing editing application cannot be updated automatically because the OS has been changed to one that does not support use of the vendor-provided printer driver. Then, the editing application in a new version can be installed using the obtained data, which enables execution of the processing for assigning the standard driver as the virtual printer driver. Specifically, even in a case where the editing application includes no update function, the editing application can be updated by a user operation, and the functions of the vendor-provided driver can be provided. Thus, the user can continue using the editing application 203.

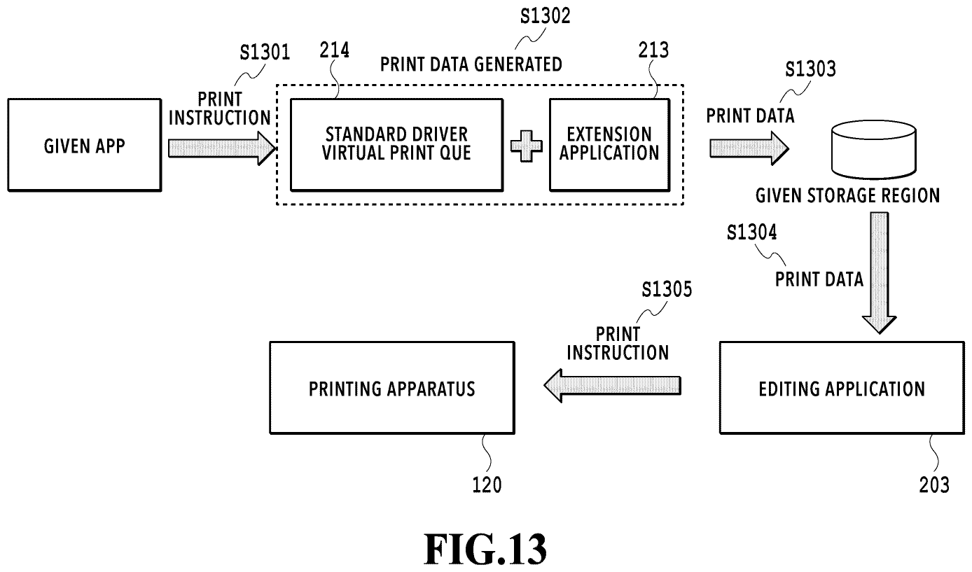

FIG. 13 is a diagram showing an example flow from issuance of a print instruction by a given application to execution of printing by the printing apparatus 120, after the assignment of the standard driver as the virtual printer driver. With reference to FIG. 13, an example is described where even in the environment that does not support use of the vendor-provided virtual printer driver, the standard driver virtual print que and the extension application make the editing application usable.

In S1301, a given application capable of issuing a print instruction issues a print instruction to the standard driver virtual print que 214. For example, the given application issues a print instruction to the standard driver virtual print que 214 upon detection of a user operation of issuing a print instruction performed on the UI of the application.

In S1302, the extension application 213 generates print data based on the print instruction issued to the standard driver virtual print que 214. In S1303, the extension application 213 saves the print data generated in S1302 to any given storage region allocated in the external storage device 114 of the host computer 101.

In S1304, the print data is passed from the given storage region to the editing application 203. In S1305, the editing application 203 performs edit processing on the print data in accordance with the user's edit operations, generating edit data from the print data. Then, the editing application issues a print instruction in response to a user operation and transmits the instruction to the printing apparatus 120 via the OS. Then, based on the print instruction received, the printing apparatus 120 executes printing.

By the extension application thus editing the content of the PDC of the standard driver virtual print que generated using the standard driver, functions similar to those of the vendor-provided virtual printer driver can be provided.

### Other Embodiments

The above embodiments describe examples where, using the OS environment determination unit 303, the CPU 111 determines whether the vendor-provided virtual printer driver 202 is installable based on version information and OS capability information; however, the determination method is not limited to this.

For example, using the OS environment determination unit 303, the CPU 111 may obtain policy-related information from the OS and determine based on the policy-related information whether the vendor-provided virtual printer driver 202 is installable.

The policy-related information is information related to policy settings for setting, e.g., the computer's system operation and software operation. Also, the policy settings include operation settings about the virtual printer driver and the like. Further, the operation settings include setting information indicating whether to prohibit execution and installation of the vendor-provided virtual printer driver 202.

Specifically, using the OS environment determination unit 303, the CPU 111 determines whether the policy-related information includes setting information prohibiting installation of the vendor-provided virtual printer driver 202. In a case where the policy-related information includes no setting information prohibiting installation of a vendor-provided virtual printer driver, the CPU 111, using the OS environment determination unit 303, determines that the current OS environment supports installation of the vendor-provided virtual printer driver. In a case where the policy-related information includes setting information prohibiting installation of a vendor-provided virtual printer driver, the CPU 111, using the OS environment determination unit 303, determines that the current OS environment does not support installation of the vendor-provided virtual printer driver.

Alternatively, before the OS environment determination, the CPU 111 may, using the virtual driver installation unit 305, start processing for installing the vendor-provided virtual printer driver 202 and determine whether the installation processing is executable.

For example, before the OS environment determination unit 303 determines whether the vendor-provided virtual printer driver 202 is installable, the CPU 111, using the virtual driver installation unit 305, starts processing for installing the vendor-provided virtual printer driver 202. Then, the CPU 111 determines whether an execution error has occurred for the installation processing.

In a case where an execution error occurs in the processing for installing the vendor-provided virtual printer driver 202, the CPU 111, using the OS environment determination unit 303, determines that the current OS environment does not support installation of the vendor-provided virtual printer driver 202. Also, in a case where an execution error does not occur in the processing for installing the vendor-provided virtual printer driver 202, the CPU 111, using the OS environment determination unit 303, determines that the current OS environment support installation of the vendor-provided virtual printer driver 202. In this way, the CPU 111 can determine the OS environment using the OS environment determination unit 303 without using the version information.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-194012, filed Nov. 5, 2024, which is hereby incorporated by reference herein in its entirety.

What is claimed is:

1. A non-transitory computer-readable storage medium storing a program of an installer for an application for causing an information processing apparatus to execute a method, the method comprising:
obtaining capability information on an operating system implemented in the information processing apparatus from the operating system and
performing, based on the capability information on the operating system, control of whether to install a first driver being a virtual printer driver provided by a vendor of a printing apparatus, or to perform processing for assigning a second driver as the virtual printer driver, the second driver being different from the first driver and being a standard driver of the operating system.

2. The storage medium according to claim 1, wherein
to the application provided by the vendor of the printing apparatus and capable of issuing a print instruction to the printing apparatus, the first driver outputs print data including setting information for printing by the printing apparatus.

3. The storage medium according to claim 1, wherein
the capability information on the operating system is information indicating whether the operating system supports use of the first driver,
the first driver is installed in a case where the capability information on the operating system indicates that the operating system supports use of the first driver, and
the processing for assigning the second driver as the virtual printer driver is performed in a case where the capability information on the operating system indicates that the operating system does not support use of the first driver.

4. The storage medium according to claim 1, wherein
the capability information on the operating system is either information indicating a version of the operating system or information indicating whether installation of the first driver is prohibited.

5. The storage medium according to claim 1, wherein
the control is performed in processing for installing the application.

6. The storage medium according to claim 5, wherein
the installation processing includes setup processing for the virtual printer driver, and
the control is performed in the setup processing.

7. A non-transitory computer-readable storage medium storing a program of an application for causing an information processing apparatus to execute a method, the method comprising:
obtaining capability information on an operating system implemented in the information processing apparatus from the operating system and
performing, based on the capability information on the operating system, control of whether to perform processing for assigning a second driver as a virtual printer driver being a first driver and provided by a vendor of a printing apparatus, the second driver being different from the first driver and being a standard driver of the operating system.

8. The storage medium according to claim 7, wherein
the control is performed in activation processing for activating the application.

9. The storage medium according to claim 8, wherein
the capability information on the operating system is information indicating whether the operating system supports use of the first driver,
the processing for assigning the second driver as the virtual printer driver is not performed in a case where the capability information on the operating system indicates that the operating system supports use of the first driver, and
the processing for assigning the second driver as the virtual printer driver is performed in a case where the capability information on the operating system indicates that the operating system does not support use of the first driver.

10. The storage medium according to claim 9, wherein
in a case where the capability information on the operating system indicates that the operating system supports use of the first driver, control to continue the activation processing is further performed.

11. The storage medium according to claim 9, wherein
the information processing apparatus is installed with the first driver, and
in a case where the capability information on the operating system indicates that the operating system does not support use of the first driver, control to delete the first driver is further performed.

12. The storage medium according to claim 9, wherein
the method further comprising:
displaying a first screen for prompting a user for an automatic update of the application in a case where the capability information on the operating system indicates that the operating system does not support use of the first driver.

13. The storage medium according to claim 12 wherein
control to execute an update of the application is further performed based on a user operation performed on the first screen.

14. The storage medium according to claim 12, wherein
in a case where the capability information on the operating system indicates that the operating system does not support use of the first driver, control to display a second screen for prompting the user for a manual update of the application is further performed.

15. The storage medium according to claim 14, wherein
based on a user operation performed on the second screen, control to issue a display instruction to display a web page for obtaining data necessary for an update of the application is further performed.

16. A method for controlling an information processing apparatus implementing an operating system and configured to execute an installer for an application on the operating system, the method comprising:
obtaining capability information on the operating system from the operating system and
based on the capability information on the operating system, performing control of whether to install a first driver being a virtual printer driver provided by a vendor of a printing apparatus, or to perform processing for assigning a second driver as the virtual printer driver, the second driver being different from the first driver and being a standard driver of the operating system.
